(19) United States
(12) Patent Application Publication
(10) Pub. No.: US 2025/0103034 A1
(43) Pub. Date: Mar. 27, 2025

(54) SYSTEM AND METHOD FOR CONTROLLING A CHEMICAL PLANT

(71) Applicant: Elixa Technologies Private Limited, Maharashtra (IN)

(72) Inventors: Vipin Raghavan, Kerala (IN); Anish Mallick, West Bengal (IN); Priyadarsihni V., Karnataka (IN)

(21) Appl. No.: 18/896,370

(22) Filed: Sep. 25, 2024

Related U.S. Application Data
(60) Provisional application No. 63/540,616, filed on Sep. 26, 2023.

(51) Int. Cl. G05B 19/418

(52) U.S. Cl. CPC G05B 19/41885; G05B 2219/32287

(57) ABSTRACT

The present disclosure relates to a system and a method for controlling a chemical plant using a machine learning technique. The method described herein includes building and updating a prediction model on a user device and/or an edge device. The method includes receiving new input data from one or more sensors of the chemical plant, saving the new input data from the one or more sensors onto a stack present in memory of the user or edge device, updating a Linear Continuous Updating (LCU) model with the new input data stored in the stack, and extrapolating current state of the chemical plant using the updated LCU model for decision making. Further, the method includes sending an output to a dosage controller of the chemical plant based on decision made, and adjusting a dosage flow meter to control a dosage flow into the chemical plant based on the output sent by the user or edge device.

### TECHNICAL FIELD

This disclosure relates generally to the field of automation in chemical processes. More particularly, the present disclosure relates to a system and a method for controlling a chemical plant using Machine Learning (ML).

### BACKGROUND

One of the goals of automation in chemical processes involves predicting certain process parameters. However, the existing prediction models are quite complex and require a high amount of processing power as well as memory. The existing approach of using ML to simplify the predicting certain process parameters also requires high processing power and memory for training. Hence, the training cannot be done on a user device and/or an edge device. The traditional approach used so far is to develop the prediction model on a more powerful system and deploy the prediction model on the user device and/or the edge device for prediction purposes. One of the problems faced with such approach is data drift, which can be described as changes in distribution of the data between training and testing. This necessitates re-training and updating the ML model periodically.

Thus, it is desired to address the above-mentioned disadvantages or other shortcomings and at least provide a useful alternative.

### SUMMARY

According to an embodiment, the present disclosure relates to a method for controlling a chemical plant. The method described herein includes building and updating a prediction model on a user device and/or an edge device. The method includes, receiving new input data from one or more sensors of the chemical plant, and saving the new input data from the one or more sensors onto a stack present in memory of a device. Thereafter, the method includes updating a Linear Continuous Updating (LCU) model with the new input data stored in the stack, and extrapolating current state of the chemical plant using the updated LCU model for decision making.

According to another embodiment, the present disclosure relates to a system for controlling a chemical plant. The system described herein includes building and updating a prediction model on a user device and/or an edge device. The system comprises a device configured to receive new input data from one or more sensors of the chemical plant, and save the new input data from the one or more sensors onto a stack present in memory of the device. Thereafter, the device is configured to update a LCU model with the new input data stored in the stack, and extrapolate current state of the chemical plant using the updated LCU model for decision making.

According to yet another embodiment, the present disclosure relates to a non-transitory computer readable medium including instructions stored thereon that when processed by a processor cause a system to perform operations comprising receiving new input data from one or more sensors of the chemical plant, and saving the new input data from the one or more sensors onto a stack present in memory of a device. Thereafter, the instruction causes the processor to update a LCU model with the new input data stored in the stack, and extrapolate current state of the chemical plant using the updated LCU model for decision making.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 is an exemplary representation of procedural flow for controlling a chemical plant in accordance with some embodiments of the present disclosure.

FIG. 2 shows a block diagram of an edge device for controlling a chemical plant in accordance with some embodiments of the present disclosure.

FIG. 3 illustrates a flowchart showing a method for controlling a chemical plant in accordance with the present disclosure.

FIG. 4 depicts a block diagram of an exemplary computing system for implementing embodiments in accordance with the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s) or disclosure(s)” unless expressly specified otherwise.

The terms “including”, “comprising”, “having” and variations thereof mean “including but not limited to”, unless expressly specified otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature.

As used herein, the term “computing device/computing system/user device/computer system/edge device” may refer to one or more electronic devices that are configured to directly or indirectly communicate with or over one or more networks. A computing device may be a mobile or portable computing device, a desktop computer, a server, and/or the like. A computing device/computer system/user device may refer to any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, etc. It may comprise any suitable hardware and software for performing such functions, and may also include multiple devices or components (e.g., when a device has remote access to a network by tethering to another device—i.e., using the other device as a relay-both devices taken together may be considered a single mobile device). Furthermore, the term “computer” may refer to any computing device that includes the necessary components to receive, process, and output data, and normally includes a display, a processor, a memory, an input device, and a network interface. A “computing system” may include one or more computing devices or computers. An “application” or “Application Program Interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used, the term “chemical plant” or “chemical processing plant” or “chemical plant system”, maybe an industrial process plant that manufactures chemicals or to create new material via the chemical or biological transformation and or separation of materials. It may comprise of one or more dosage controllers to control the inflow of effluents. It may further include one or more sensors to detect the progression of a chemical process or to detect one or more further aspects of the chemical process.

As used herein, the term “sensor”, may refer to any suitable sensor that is configured to directly or indirectly communicate with a user device or a computer system. It may refer to, but is not limited to, chemical sensors, level sensors, pressure sensors, temperature sensors, fluid property sensors, flow meter sensors, or dosage flow meter sensors.

As used herein, the term “dosage controller”, may refer to controllers in chemical plants used to operate and monitor the chemical plants and adjust and maintain, processing units and equipment which distil, filter, separate, heat or refine chemicals.

As used herein, the term “application” may refer to a computer code or other data stored on a computer readable medium (e.g., memory element or secure element) that may be executable by a processor to complete a task.

As used herein, the term “server computer” is typically a high performance computer or cluster of computers. For example, the server computer can be a large mainframe, a minicomputer cluster, or a group of servers functioning as a unit. In one example, the server computer may be a database server coupled to a Web server.

As used herein, the term “processor” may refer to any suitable data computation device or devices. A processor may comprise one or more microprocessors working together to accomplish a desired function. The processor may include Central Processing Unit (CPU) comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

As used herein, the term “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behaviour of the systems and/or methods are described herein without reference to specific software code, it being understood that software and hardware can be designed to implement the systems and/or methods based on the description herein.

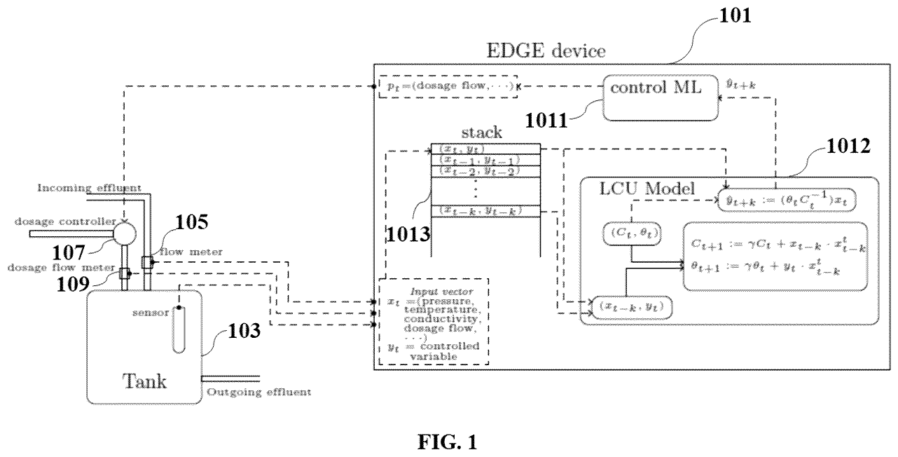

FIG. 1 is an exemplary representation of procedural flow for controlling a chemical plant in accordance with some embodiments of the present disclosure.

With reference to FIG. 1, the environment comprises of an edge device (also, referred as a user device) 101, a chemical plant (also, referred as a tank) 103, a flow meter 105, a dosage controller 107, and a dosage flow meter 109. In one embodiment, a system comprises only the edge device 101. In another embodiment, the system comprises the edge device 101 and the dosage controller 107. The edge device 101 is communicatively connected to the dosage controller 107 through a communication network (not shown in FIG. 1). Analogously, the edge device 101 is communicatively connected to the flow meter 105 (to measure a flow of an incoming effluent into the chemical plant 103), and the dosage flow meter 109 (to measure flow of a dosage into the chemical plant 103) through their respective sensors and the communication network. Further, there may be additional sensors directly or indirectly attached to the chemical plant 103 to collect input data (or new input data), not limited to, related to at least one of a pressure inside the chemical plant 103, a temperature of the chemical plant 103, and a conductivity of an effluent inside the chemical plant 103. These additionally sensors are communicatively connected to the edge device 101 through the communication network. The sensors of the flow meter 105, and the dosage flow meter 109 along with the additional sensors directly or indirectly attached to the chemical plant 103 may be collectively referred as one or more sensors.

The communication network involves any of the following communication methods or protocols, but is not limited to, a direct interconnection, an e-commerce network, a Peer-to-peer (P2P) network, LAN, WAN, wireless network (for example, using Wireless Application Protocol), Internet, Wi-Fi, Bluetooth, and the like.

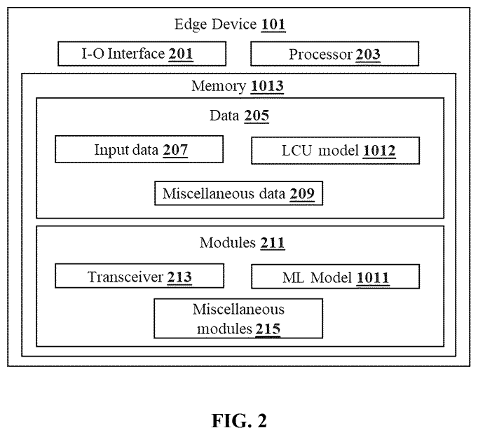

In the embodiment, the edge device 101 receives new input data from one or more sensors of the chemical plant 103 and sends an output to the dosage controller 107 of the chemical plant 103 via an I-O interface 201 of the edge device 101 (refer FIG. 2). The edge device 101 include the I-O interface 201, a memory 1013, and a processor 203, as shown in FIG. 2. The new input data received via the I-O interface 201 is stored in the memory or stack 1013 of the edge device 101. The memory 1013 is communicatively connected to the processor 203 of the edge device 101. The memory 1013, also, stores processor instructions which cause the processor 203 to execute the instructions for controlling the chemical plant 103.

The operation for controlling the chemical plant 103 is explained below.

The edge device 101 receives new input data from one or more sensors of the chemical plant 103. In detail, the one or more sensors may be communicatively connected directly or indirectly to the chemical plant 103. The new input data may comprise, but not limited to, at least one of a pressure inside the chemical plant 103, a temperature of the chemical plant 103, a conductivity of an effluent inside the chemical plant 103, a flow of an incoming effluent into the chemical plant 103, and a flow of a dosage into the chemical plant 103. Thereafter, the edge device 101 saves the new input data from one or more sensors onto the memory or stack 1013 of the edge device 101. Using the new input data, the edge device 101 updates a Linear Continuous Updating (LCU) model 1012. The LCU model 1012 may be, but is not limited to, a linear type model or a polynomial type model. The linear type model may be based on a least square linear regression method. The polynomial type model may be based on a ridge regression method or a lasso regression method. Using the updated LCU model 1012, the edge device 101 extrapolates current state of the chemical plant 103 for decision making. The extrapolating the current state of the chemical plant 103 refers to forecasting future state of the chemical plant 103 based on the updated LCU model 1012. Thereafter, the edge device 101 sends an output to the dosage controller 107 of the chemical plant 103 based on decision made. Upon receiving the output from the edge device 101, the dosage controller 107 adjusts the dosage flow meter 109 to control a dosage flow into the chemical plant 103 based on the output sent by the edge device 101.

Hereinafter, an implementation of the LCU model 1012 in the edge device 101 for controlling the chemical plant 103 is explained below.

In an embodiment, given a discrete time series {xₙ, yₙ}_{n≥1}, where xₙ∈Rⁿ and yₙ∈R, a prediction function f_{N} is defined, which depends only on the past data {xₙ, yₙ}ₙ₌₁^{N}. f_{N} may be used to compute f_{N}(x_{N+1}) as prediction for y_{N+1}.

In an embodiment, the least square linear regression method comprises the following: For the least square linear regression,

$$\begin{matrix}{C}_{N} = {\sum }_{n = 1}^{N} {x}_{n} {x}_{n}^{t} & \& & {\hat{y}}_{N =} {\sum }_{n = 1}^{N} {y}_{n} {x}_{n}^{t}\end{matrix} \qquad ( 1 )$$

Wherein xₙ is a column vector, and t is the transpose of the vector. The parameter θ_{N}^{t} for least square regression is given by:

$${θ}_{N}^{t} = {C}_{N}^{- 1} {\hat{y}}_{N} \qquad ( 2 )$$

(assuming C_{N} is invertible), and the prediction function is \hat{f}(x)=θ_{N}^{t}x. For linear model {C_{N}, ŷ_{N}}_{N} is required, but by definition

$$\begin{matrix}{C}_{N + 1} = {C}_{N} + {x}_{N + 1} {x}_{N + 1}^{t} & \& & {\hat{y}}_{N + 1} = {\hat{y}}_{N} + {y}_{N + 1} {x}_{N + 1}^{t}\end{matrix} \qquad ( 3 )$$

This defines the updating step for the model. The parameter ON obtained from the equation (2) by following the equation (3) minimizes

$${L}_{N} ( θ ) = {\sum }_{i = 1}^{N} {( {y}_{i} - {θ}^{t} {x}_{i} )}^{2} ,$$

which is equivalent to stating that all previous points have equal weight.

In an embodiment, to improve error estimate for recent data while not taking into account past data may be done by:

$$\begin{matrix}{C}_{N + 1} = γ {C}_{N} + {x}_{N + 1} {x}_{N + 1}^{t} & \& & {\hat{y}}_{N + 1} = γ {\hat{y}}_{N} + {y}_{N + 1} {x}_{N + 1}^{t}\end{matrix} \qquad ( 4 )$$

for 0<γ<1. The parameter θ_{N} obtained from the equation (2) using the recursion from the equation (4) minimizes

$${L}_{{N}_{N}}^{γ} ( θ ) = {\sum }_{i = 1}^{N} {{γ}^{N - i} ( {y}_{i} - {θ}^{t} {x}_{i} )}^{2}$$

By selecting γ correctly, the effect of past data on the prediction can be tuned. Using the recursion from the equation (4) also has the effect of avoiding numerical overflow, which will eventually happen if the equation (3) is used.

In an embodiment, the ridge regression method comprises the following: To compute the parameter θ_{N}, C_{N} is to be inverted. But C_{N} may not be invertible for various reasons, one way to avoid it is to use the ridge regression method, and compute

$${θ}_{N} = {( κ I + {C}_{N} )}^{- 1} {\hat{y}}_{N}$$

for κ>0. For the recursion from the equation (4), θ_{N} defined above minimizes

$${L}_{N}^{γ , κ , Υ} ( θ ) = {\sum }_{i = 1}^{N} {γ}^{N - i} ( {( {y}_{i} - {θ}^{t} {x}_{i} )}^{2} + κ {‖ θ ‖}_{2}^{2} )$$

In another embodiment, the inversion problem can be avoided through eigenvalue decomposition of C_{N}. Let U_{N} be the unitary matrix such that C_{N}=U_{N}*D_{N} U_{N} where, D_{N}=diag(d₁, . . . , dₖ, 0, . . . ) is diagonal. D_{N}^{inv}=diag(d₁⁻¹, . . . , dₓ⁻¹, 0, . . . ) can be used to define θ_{N}=U_{N}*D_{N}^{inv}U_{N}ŷ_{N}. This can be used as ŷ_{N} lies in the complement of null space of C_{N}.

In an embodiment, the lasso regression method, similar to the ridge regression method, may be used to minimize

$${L}_{N}^{γ , κ , Υ} ( θ ) = {\sum }_{i = 1}^{N} {γ}^{N - i} ( {( {y}_{i} - {θ}^{t} {x}_{i} )}^{2} + κ {‖ θ ‖}_{1} )$$

As ∥θ∥₁ is not differentiable in all scenarios, derivative of the above equation is defined:

$$\partial {L}_{N}^{γ , κ , Υ} ( θ ) = 2 ( {θ}^{t} {C}_{N -} {\hat{y}}_{N} ) + {D}_{N}^{γ} κ {ω}_{θ}$$

Where ω_{θ} is the vector, where at the i^{th} position sign of θᵢ (θᵢ/|θᵢ| for θᵢ≠0), here D_{N}^{Y}(θ)=Σᵢ₌₁^{N}γ^{N-i}. This may be minimized using variants of gradient descent to obtain the parameter.

The parameters C_{N} and θ_{N} may be referred as internal or current state of the chemical plant 103. The xₙ and yₙ refer to input data or new input data that comprises, but not limited to, at least one of a pressure inside the chemical plant 103, a temperature of the chemical plant 103, a conductivity of an effluent inside the chemical plant 103, a flow of an incoming effluent into the chemical plant 103, and a flow of a dosage into the chemical plant 103.

In an embodiment, the least square regression method with continuous update routine is given by technique below:

Class LiveModel (d, T, γ)

| /* Define d, T, γ for the class. */
| /* d is dimension of the data. */

| | |
|---|---|
| \| /* γ is renormalization factor to reduce the effect of history from the model. | */ |
| \| /* T is number of update steps to follow between two renormalization. | */ |

| Function Initialization
| | | C ← Identity matrix of rank d;
| | | ŷ ← Zero vector of dimension d;
| | | counter ← 0;
| End
| Function Update (υ,y)

| | | |
|---|---|---|
| \| \| \| /* υ is a row vector of dimension d. | | */ |
| \| \| \| /* y is signal corresponding to υ observed. | | */ |
| \| \| \| C ← C +υ^{t}υ; | /* updating C | */ |
| \| \| \| ŷ ← ŷ +υ^{t}υ; | /* updating C | */ |

| | | counter ← counter + 1;
| | | if counter > T then

| | |
|---|---|
| \| \| \| \| /* Renormalization routine | */ |

| | | | counter ← 0;
| | | | C ← γC;
| | | | ŷ ← γŷ;
| | | End
| | End
| Function Predict (υ)

| | | |
|---|---|---|
| \| \| /* υ is a row vector of dimension d. | | */ |
| \| \| θ ← C⁻¹ · ŷ ; | /* computing the parameter | */ |
| \| \| return υ · θ ; | /* Prediction | */ |

| End

Technique for continuous update for a least square regression method.

FIG. 2 shows a block diagram of an edge device for controlling a chemical plant in accordance with some embodiments of the present disclosure.

In one embodiment, the system comprises only the edge device 101. The edge device 101 include an I-O interface 201, a processor 203, data 205, and one or more modules 211 (also, referred as modules), which are described herein in detail.

The edge device 101 communicates with the dosage controller 107 (not shown in FIG. 2) via the I-O interface 201 and a communication network (not shown in FIG. 2). The I-O interface 201 employs communication protocols or methods such as, without limitation, Bluetooth, cellular e.g., CDMA, HSPA+, GSM, LTE, NR, WiMax, NG interface, or the like.

The processor 203 includes at least one data processor for controlling the chemical plant 103. The processor 203 includes specialized processing units such as, without limitation, integrated system (bus) controllers, memory management control units, floating point units, graphics processing units, digital signal processing units, etc.

In an embodiment, the data 205 may be stored within the memory 1013. The memory 1013 is communicatively connected to the processor 203 of the edge device 101. The memory 1013, also, store processor instructions which may cause the processor 203 to execute the instructions for controlling the chemical plant 103. The memory 1013 includes, without limitation, memory drives, etc. The memory drives may further include a drum, magnetic disc drive, magneto-optical drive, optical drive, RAID, solid-state memory devices, solid-state drives, etc.

The data 205 may include, for example, input data 207, a LCU model 1012, and miscellaneous data 209.

The input data 207 stores new input data that comprises, but not limited to, at least one of a pressure inside the chemical plant 103, a temperature of the chemical plant 103, a conductivity of an effluent inside the chemical plant 103, a flow of an incoming effluent into the chemical plant 103, and a flow of a dosage into the chemical plant 103.

The LCU model 1012 refers to the LCU model 1012 (as shown in FIG. 1) stored in the data 205. The LCU model is one of a linear type model or a polynomial type model. The linear type model is based on a least square linear regression method, and the polynomial type model is based on a ridge regression method or a lasso regression method.

The miscellaneous data 209 stores data, including temporary data and temporary files, generated by one or more modules 211 for controlling the chemical plant 103.

In an embodiment, the data 205 in the memory 1013 are processed by the one or more modules 211 present within the memory 1013 of the edge device 101. The one or more modules 211 may be implemented as dedicated hardware units. As used herein, the term module refers to at least one of an Application Specific Integrated Circuit (ASIC), an electronic circuit, a Field-programmable Gate Array (FPGA), a combinational logic circuit, and other suitable components that provide the described functionality. In some implementations, the one or more modules 211 are communicatively connected to the processor 203 for performing one or more functions of the edge device 101. The one or more modules 211 when configured with the functionality defined in the present disclosure results in a novel hardware.

In one implementation, the one or more modules 211 include, but are not limited to, a transceiver 213, and a ML model 1011. The one or more modules 211, also, include miscellaneous modules 215 to perform various miscellaneous functionalities of the edge device 101.

The transceiver 213 is configured to receive new input data from one or more sensors of a chemical plant 103. The new input data comprises, but not limited to, at least one of a pressure inside the chemical plant 103, a temperature of the chemical plant 103, a conductivity of an effluent inside the chemical plant 103, a flow of an incoming effluent into the chemical plant 103, and a flow of a dosage into the chemical plant 103. Thereafter, the transceiver 213 is configured to save the new input data from the one or more sensors onto the stack or the memory 1013 of the edge device 101. Based on the decision made by the ML model 1011, the transceiver 213 is configured to send an output to the dosage controller 107 of the chemical plant 103 for controlling the chemical plant 103.

The ML model 1011 is configured to update the LCU model 1012 (stored in the stack or the memory 1013 of the edge device 101) with the new input data stored in the stack 1013. The LCU model 1012 is one of a linear type model or a polynomial type model. The linear type model is based on a least square linear regression method. The polynomial type model is based on a ridge regression method or a lasso regression method. Thereafter, the ML model 1011 is configured to extrapolate current state of the chemical plant 103 using the updated LCU model 1012 for decision making. The extrapolating the current state of the chemical plant 103 refers to forecasting future state of the chemical plant 103 based on the updated LCU model 1012. The ML model 1011 is trained to learn relationship between the current state of the chemical plant 103 and the new input data using the LCU model 1012 to forecast future state of the chemical plant 103.

In another embodiment, the system comprises the edge device 101 and the dosage controller 107 (not shown in FIG. 2). The dosage controller 107 is communicatively connected to the edge device 101. The dosage controller 107 is configured to receive the output, from the edge device 101, based on decision made by the edge device 101. Thereafter, the dosage controller 107 is configured to adjust the dosage flow meter 109 to control a dosage flow into the chemical plant 103 based on the output sent by the edge device 101, thereby, controlling the chemical plant 103.

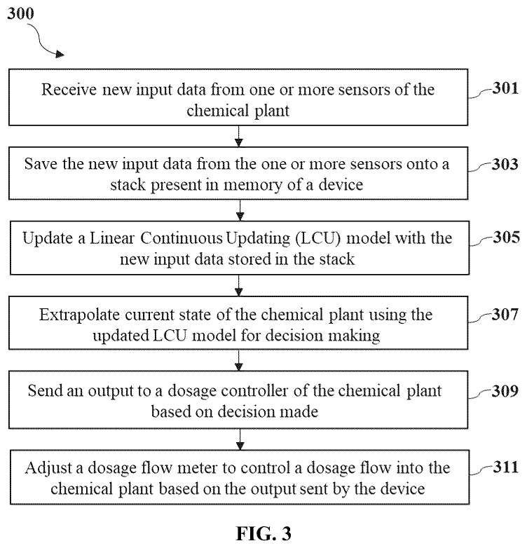

FIG. 3 illustrates a flowchart showing a method for controlling a chemical plant in accordance with the present disclosure.

As illustrated in FIG. 3, the method 300 includes one or more steps for controlling a chemical plant 103 in accordance with some embodiments of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method steps can be combined in any order to implement the method. Additionally, individual steps may be deleted from the methods without departing from the scope of the subject matter described herein. Furthermore, the method can be implemented in any suitable hardware, software, firmware, or combination thereof.

At step 301, the transceiver 213 of the edge device 101 receives new input data from one or more sensors of the chemical plant 103. The new input data comprises, but not limited to, at least one of a pressure inside the chemical plant 103, a temperature of the chemical plant 103, a conductivity of an effluent inside the chemical plant 103, a flow of an incoming effluent into the chemical plant 103, and a flow of a dosage into the chemical plant 103.

At step 303, the transceiver 213 of the edge device 101 saves the new input data from the one or more sensors onto the stack 1013 present in a memory of the edge device 101.

At step 305, the ML model 1011 of the edge device 101 updates the LCU model 1012 with the new input data stored in the stack 1013. The LCU model 1012 is one of a linear type model or a polynomial type model. The linear type model is based on a least square linear regression method. The polynomial type model is based on a ridge regression method or a lasso regression method.

At step 307, the ML model 1011 of the edge device 101 extrapolates current state of the chemical plant 103 using the updated LCU model 1012 for decision making. The extrapolating the current state of the chemical plant 103 refers to forecasting future state of the chemical plant 103 based on the updated LCU model 1012.

At step 309, the transceiver 213 of the edge device 101 sends an output to the dosage controller 107 of the chemical plant 103 based on the decision made.

At step 311, the dosage controller 107 adjusts the dosage flow meter 109 to control a dosage flow into the chemical plant 103 based on the output sent by the edge device 101.

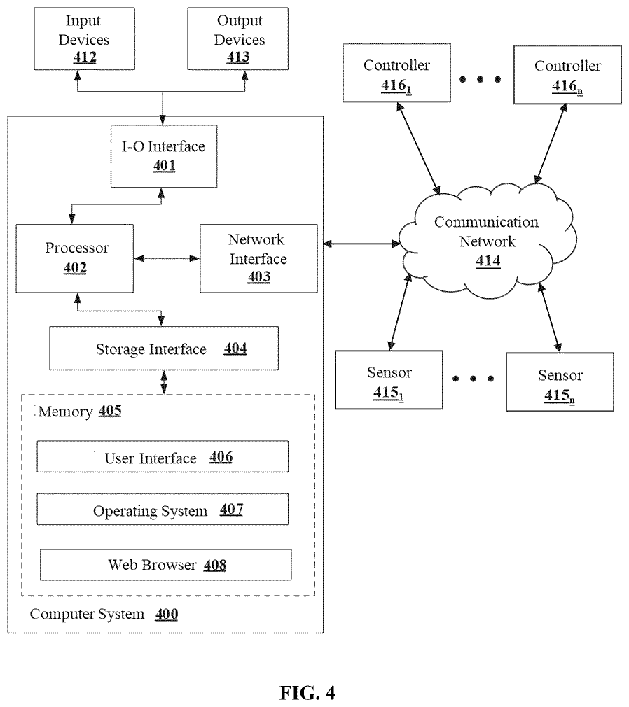

FIG. 4 depicts a block diagram of an exemplary computing system for implementing embodiments in accordance with the present disclosure.

In one embodiment, the computer system 400 is used to implement the system of the present disclosure for controlling the chemical plant 103. The processor 402 may include specialized processing units such as integrated system (bus) controllers, memory management control units, floating point units, graphics processing units, digital signal processing units, etc.

The processor 402 may be disposed in communication with input devices 412 and output devices 413 via an I-O interface 401. The I-O interface 401 may employ communication protocols or methods such as, without limitation, audio, analog, digital, stereo, IEEE-1393, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc. Using the I-O interface 401, the computer system 400 may communicate with the input devices 412 and the output devices 413.

In some embodiments, the processor 402 may be disposed in communication with a communication network 414 via a network interface 403. The network interface 403 may communicate with the communication network 414. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 414 can be implemented as one of the different types of networks, such as intranet or Local Area Network (LAN), Closed Area Network (CAN) and the like. The communication network 414 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 414 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to the memory 405 including, without limitation, memory drives, removable disc drives, etc., employing connection protocols such as Serial Advanced Technology Attachment (SATA), Integrated Drive Electronics (IDE), IEEE-1393, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The communication network 414 may be in communication with one or more sensors 415₁, 415₂ . . . 415ₙ of the chemical plant 103. The one or more sensors 415₁, 415₂. . . 415ₙ may communicate readings in the form of new input data to the computer system 400 via the communication network 414. The communication network 414 may be in communication with one or more dosage controllers 416₁, 416₂ . . . 416ₙ of the chemical plant 103. The computer system 400 may communicate, via the communication network 414, with the one or more dosage controllers 416₁, 416₂ . . . 416ₙ based on a decision made by the ML model 1011 (not shown in FIG. 4) implemented on the computer system 400.

The memory 405 may store a collection of program or database components, including, without limitation, a user interface 406, an operating system 407, a web browser 408, etc. In some embodiments, the computer system 400 may store user/application data (not shown in FIG. 4), such as the data, variables, records, etc. as described in this disclosure. Such databases may be implemented as fault-tolerant, relational, scalable, secure databases such as Oracle or Sybase.

The memory 405 may comprise a (memory) stack to store input data from the one or more sensors 415₁, 415₂ . . . 415ₙ. The memory 405 may comprise the LCU model 1012. In an embodiment, the LCU model 1012 described here maybe, but is not limited to, a linear type model or a polynomial type model. The linear type model may be based on a least square linear regression method. The polynomial type model may be based on a ridge regression method or a lasso regression method.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. The user interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) (not shown in FIG. 4) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browser 408 may utilize facilities such as AJAX, DHTML, ADOBE® FLASH®, JAVASCRIPT®, JAVA®, Application Programming Interfaces (APIs), etc. In some embodiments, the computer system 400 may implement a mail server (not shown in FIG. 4) stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client (not shown in FIG. 4) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Some of the advantages of the present disclosure are as following:

The present disclosure overcomes the requirement of a high-performance computer for processing data and training ML/LCU models.

The present disclosure overcomes the requirement for a high amount of memory storage as present disclosure can be easily implemented on an edge device or a user device.

As the present disclosure can be easily implemented on the user device and/or the edge device, the problem of data drift (refer background section) is overcome.

Some of the clauses are mentioned below.

[1]: A method for controlling a chemical plant, the method comprising:
receiving new input data from one or more sensors of the chemical plant;
saving the new input data from the one or more sensors onto a stack present in memory of a device;
updating a LCU model with the new input data stored in the stack; and
extrapolating current state of the chemical plant using the updated LCU model for decision making.

[2]: The method as described in [1], further comprising:

sending an output to a dosage controller of the chemical plant based on decision made.

[3]: The method as described in [2], further comprising:

adjusting a dosage flow meter to control a dosage flow into the chemical plant based on the output sent by the device.

[4]: The method as described in [1], wherein the extrapolating the current state of the chemical plant refers to forecasting future state of the chemical plant based on the updated LCU model.

[5]: The method as described in [1], wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

[6]: The method as described in [1], wherein the LCU model is one of a linear type model or a polynomial type model.

[7]: The method as described in [6], wherein the linear type model is based on a least square linear regression method, and

wherein the polynomial type model is based on a ridge regression method or a lasso regression method.

[8]: A system for controlling a chemical plant, the system comprising:
a device configured to:
receive new input data from one or more sensors of the chemical plant;
save the new input data from the one or more sensors onto a stack present in memory of the device;
update a LCU model with the new input data stored in the stack; and
extrapolate current state of the chemical plant using the updated LCU model for decision making.

[9]: The system as described in [8], wherein the device is configured to:

send an output to a dosage controller of the chemical plant based on decision made.

[10]: The system as described in [9], wherein the system comprises:
the dosage controller communicatively connected to the device and is configured to:
   adjust a dosage flow meter to control a dosage flow into the chemical plant based on the output sent by the device.

[11]: The system as described in [8], wherein the extrapolating the current state of the chemical plant refers to forecasting future state of the chemical plant based on the updated LCU model.

[12]: The system as described in [8], wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

[13]: The system as described in [8], wherein the LCU model is one of a linear type model or a polynomial type model.

[14]: The system as described in [13], wherein the linear type model is based on a least square linear regression method, and

wherein the polynomial type model is based on a ridge regression method or a lasso regression method.

[15]: A non-transitory computer readable medium including instructions stored thereon that when processed by a processor cause a system to perform operations comprising:
receiving new input data from one or more sensors of the chemical plant;
saving the new input data from the one or more sensors onto a stack present in memory of a device;
updating a LCU model with the new input data stored in the stack; and
extrapolating current state of the chemical plant using the updated LCU model for decision making.

[16]: The medium as described in [15], wherein the instruction causes the processor to:

send an output to a dosage controller of the chemical plant based on decision made.

[17]: The medium as described in [16], wherein the instruction causes the processor to:

adjust a dosage flow meter to control a dosage flow into the chemical plant based on the output sent by the device.

[18]: The medium as described in [15], wherein the extrapolating the current state of the chemical plant refers to forecasting future state of the chemical plant based on the updated LCU model.

[19]: The medium as described in [15], wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

[20]: The medium as described in [15], wherein the LCU model is one of a linear type model or a polynomial type model,
wherein the linear type model is based on a least square linear regression method, and
wherein the polynomial type model is based on a ridge regression method or a lasso regression method.

Furthermore, one or more computer readable storage media may be utilized in implementing embodiments consistent with the present disclosure. A computer readable storage medium refers to any type of physical memory on which information or data readable by a processor may be stored. Thus, a computer readable storage medium stores instructions for execution by one or more processors, including instructions for causing the processor(s) to perform steps or stages consistent with the embodiments described herein. The term “computer readable medium” should be understood to include tangible items and exclude carrier waves and transient signals, i.e., be non-transitory. Examples include Random Access Memory (RAM), Read Only Memory (ROM), volatile memory, non-volatile memory, hard drives, Compact Disc (CD) ROMs, Digital Versatile Disks (DVDs), flash drives, disks, and any other known physical storage media.

The described operations may be implemented as a method, an individual unit, system, or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, and the like), optical storage (CD ROMs, DVDs, optical disks, and the like), volatile and non-volatile memory devices (e.g., EEPROMs, ROMs, PROMs, RAMs, DRAMs, SRAMs, Flash Memory, firmware, programmable logic, and the like) and the like. Further, non-transitory computer readable media include all computer readable media except for a transitory. The code implementing the described operations may further be implemented in hardware logic (e.g., an integrated circuit chip, Programmable Gate Array (PGA), Application Specific Integrated Circuit (ASIC) and the like).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s) or disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention or disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention or disclosure need not include the device itself.

The illustrated operations of FIG. 3 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention or disclosure be limited not by this detailed description, but rather by any claims that issue on an application based here on. Accordingly, the disclosure of the embodiments of the invention or disclosure is intended to be illustrative, but not limiting, of the scope of the invention or disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the scope being indicated by the following claims.

REFERRAL NUMERALS:

| Reference number | Description |
|---|---|
| 101 | Edge device |
| 1011 | Control ML or ML model |
| 1012 | LCU model |
| 1013, 405 | Stack or memory |
| 103 | Tank or Chemical plant |
| 105 | Flow meter |
| 107 | Dosage controller |
| 109 | Dosage flow meter |
| 201, 401 | Input-Output (I-O) interface |
| 203, 402 | Processor |
| 205 | Data |
| 207 | Input data |
| 209 | LCU model |
| 211 | Miscellaneous data |
| 211 | Modules |
| 213 | Transceiver |
| 215 | Miscellaneous modules |
| 400 | Computer system |
| 403 | Network interface |
| 404 | Storage interface |
| 406 | User interface |
| 407 | Operating system |
| 408 | Web browser |
| 412 | Input devices |
| 413 | Output devices |
| 414 | Communication interface |
| 415₁ . . . 415ₙ | Plurality of sensors |
| 416₁ . . . 416ₙ | Plurality of controllers |

What is claimed is:

1. A method for controlling a chemical plant, the method comprising:
receiving new input data from one or more sensors of the chemical plant;
saving the new input data from the one or more sensors onto a stack present in memory of a device;
updating a Linear Continuous Updating (LCU) model with the new input data stored in the stack; and
extrapolating current state of the chemical plant using the updated LCU model for decision making.

2. The method of claim 1, further comprising:
sending an output to a dosage controller of the chemical plant based on decision made.

3. The method of claim 2, further comprising:
adjusting a dosage flow meter to control a dosage flow into the chemical plant based on the output sent by the device.

4. The method of claim 1, wherein the extrapolating the current state of the chemical plant refers to forecasting future state of the chemical plant based on the updated LCU model.

5. The method of claim 1, wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

6. The method of claim 1, wherein the LCU model is one of a linear type model or a polynomial type model.

7. The method of claim 6, wherein the linear type model is based on a least square linear regression method, and
wherein the polynomial type model is based on a ridge regression method or a lasso regression method.

8. A system for controlling a chemical plant, the system comprising:
a device configured to:
receive new input data from one or more sensors of the chemical plant;
save the new input data from the one or more sensors onto a stack present in memory of the device;
update a Linear Continuous Updating (LCU) model with the new input data stored in the stack; and
extrapolate current state of the chemical plant using the updated LCU model for decision making.

9. The system of claim 8, wherein the device is configured to:
send an output to a dosage controller of the chemical plant based on decision made.

10. The system of claim 9, wherein the system comprises:
the dosage controller communicatively connected to the device and is configured to:
adjust a dosage flow meter to control a dosage flow into the chemical plant based on the output sent by the device.

11. The system of claim 8, wherein the extrapolating the current state of the chemical plant refers to forecasting future state of the chemical plant based on the updated LCU model.

12. The system of claim 8, wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

13. The system of claim 8, wherein the LCU model is one of a linear type model or a polynomial type model.

14. The system of claim 13, wherein the linear type model is based on a least square linear regression method, and
wherein the polynomial type model is based on a ridge regression method or a lasso regression method.

15. A non-transitory computer readable medium including instructions stored thereon that when processed by a processor cause a system to perform operations comprising:
receiving new input data from one or more sensors of the chemical plant;
saving the new input data from the one or more sensors onto a stack present in memory of a device;
updating a Linear Continuous Updating (LCU) model with the new input data stored in the stack; and
extrapolating current state of the chemical plant using the updated LCU model for decision making.

16. The medium of claim 15, wherein the instruction causes the processor to:
send an output to a dosage controller of the chemical plant based on decision made.

17. The medium of claim 16, wherein the instruction causes the processor to:
adjust a dosage flow meter to control a dosage flow into the chemical plant based on the output sent by the device.

18. The medium of claim 15, wherein the extrapolating the current state of the chemical plant refers to forecasting future state of the chemical plant based on the updated LCU model.

19. The medium of claim 15, wherein the new input data comprises at least one of a pressure inside the chemical plant, a temperature of the chemical plant, a conductivity of an effluent inside the chemical plant, a flow of an incoming effluent into the chemical plant, and a flow of a dosage into the chemical plant.

20. The medium of claim 15, wherein the LCU model is one of a linear type model or a polynomial type model,
wherein the linear type model is based on a least square linear regression method, and
wherein the polynomial type model is based on a ridge regression method or a lasso regression method.
